(19) United States
(12) Patent Application Publication
(10) Pub. No.: US 2020/0199493 A1
(43) Pub. Date: Jun. 25, 2020

(54) UNIT DOSE DETERGENT WITH ZINC RICINOLEATE

(71) Applicant: Henkel IP & Holding GmbH, Duesseldorf (DE)

(72) Inventor: Daniel T. Piorkowski, Fairfield, CT (US)

(73) Assignee: Henkel IP & Holding GmbH, Duesseldorf (DE)

(21) Appl. No.: 16/229,472

(22) Filed: Dec. 21, 2018

(51) Int. Cl. C11D 3/20; C11D 17/04; C11D 3/43; C11D 1/83; C11D 3/30; C11D 11/00

(52) U.S. Cl. CPC C11D 3/2086; C11D 17/043; C11D 3/43; C11D 1/29; C11D 3/30; C11D 11/0094; C11D 1/8305

(57) ABSTRACT

A unit dose detergent product including: a pouch made of a water soluble polymer, and a detergent composition encapsulated in the pouch, wherein the detergent composition includes: 0.2 to 5 wt. % of zinc ricinoleate (ZnR), 10 to 20 wt. % of a C₂-C₅ polyol; 5 to 30 wt. % of water; 5 to 25 wt. % of an alkali ethoxy alkyl sulfate surfactant; and 10 to 25 wt. % of an ethoxylated alcohol nonionic surfactant, and 1 to 10 wt. % of a third surfactant, wherein the third surfactant has a mean HLB of 2 to 10.

### FIELD OF THE INVENTION

The invention relates to unit dose detergent compositions. Specifically, this invention relates to stable unit dose detergent compositions having zinc ricinoleate as a malodor reduction agent.

### BACKGROUND OF THE INVENTION

Unit dose detergent compositions have seen increasing adoption by consumers over the past few years. Unit dose detergent compositions include a liquid and/or solid detergent composition in a water soluble polymer film When the unit dose is placed in a washing machine, the film dissolves, releasing the dose of detergent composition into the wash. The detergent composition is then available to perform the desired cleaning and/or other functions. Unit dose detergent compositions avoid the need to measure a specific amount of a detergent composition into a wash. Unit dose detergent compositions also avoid spills and similar transfer of detergent compositions to the surroundings.

The unit dose detergent includes a water soluble film which dissolves and releases the detergent composition into the wash liquid. The dilution from the detergent composition to the concentration in the wash liquid may be substantial, for example, over multiple orders of magnitude. A variety of factors encourage the use of smaller unit dose detergent composition packages, including storage size, cost of the film used to contain the unit dose, etc. Generally speaking, consumers may prefer smaller detergent composition dose formulations as convenient and storable.

In general, unit dose detergent compositions include lower concentrations of solvents, such as water. Unit dose detergent compositions may also use other solvents and/or mixtures of solvents to increase the storage stability of the water soluble film in contact with the detergent composition. However, it is desirable that materials in the detergent composition remain soluble in the unit dose detergent composition and similarly when mixed into the wash liquid. In contrast, it is undesirable for components to precipitate and/or otherwise form solid phases. Such phases may slow the mixing of the material into the wash liquid and delay its availability during washing. Precipitates may also be perceived as a quality issue by consumers as they may impart a cloudy appearance to the detergent formulation. Accordingly, it is desirable to maintain solubility of all components of the unit dose detergent formulation during storage and use of the product.

Zinc ricinoleate has been used in deodorants as an odor absorbing agent. There is no known solution to delivering ZnR to a unit dose detergent composition due to flocculation and sedimentation of the ZnR when added over 0.15% by weight on an active basis to detergents. This instability worsens when samples are at higher temperatures.

However, to provide a detectable malodor reduction effect, it is recommended that at least 0.3 grams of ZnR be provided per wash load. The use level of 0.3 grams per wash roughly is equivalent to 1.5% by weight of the formula of active ZnR for a detergent unit dose of 20 grams. A level of 1.5 wt. % of the formulation of ZnR, in turn, is 10 times the threshold ZnR level that caused precipitation (0.15 wt. %).

There is a need to provide a stable unit dose detergent product that contains a high level of ZnR for effective malodor reduction and elimination.

### BRIEF SUMMARY OF THE INVENTION

Among other embodiments, this specification describes a unit dose detergent product including: a pouch made of a water soluble polymer, and a detergent composition encapsulated in the pouch, wherein the detergent composition includes: 0.2 to 5 wt. % of zinc ricinoleate (ZnR), 10 to 20 wt. % of a C₂-C₅ polyol; 5 to 30 wt. % of water; 5 to 25 wt. % of an alkali ethoxy alkyl sulfate surfactant; and 10 to 25 wt. % of an ethoxylated alcohol nonionic surfactant, and 1 to 10 wt. % of a third surfactant, wherein the third surfactant has a mean Hydrophilic-Lipophilic Balance (HLB) of 2 to 10.

Each wt. % is based on the total of weight of the detergent composition unless otherwise stated.

The unit does detergent is shelf-stable, meaning the detergent composition remains a liquid without precipitating for a useful period of time. Preferably, the detergent composition remains liquid without precipitating for 30 days at 24° C. (75° F.); more preferably, the detergent composition remains liquid without precipitating for 90 days at 24° C. (75° F.); and most preferably, the detergent composition remains liquid without precipitating for no less than 365 days at 24° C. (75° F.).

In an embodiment, zinc ricinoleate (ZnR) makes up between 0.2 and 5 wt. % of the detergent composition; preferably, ZnR makes up between 0.5 and 4 wt. % of the detergent composition; more preferably, ZnR makes up 1 to 3 wt. % of the detergent composition; and most preferably, ZnR makes up 1.3 to 2.7 wt. % of the detergent composition.

It has been unexpectedly discovered that ZnR, if added to the detergent composition as a melt from a solid ZnR source which contains at least 70 wt. % ZnR active, produces a unit dose detergent product with a greater stability, compared to a unit dose detergent product wherein ZnR is added into the detergent composition from a lower ZnR content source, such as a solution or suspension containing about 30% of ZnR active. At a low concentration of ZnR (e.g., up to about 30%), ZnR may be in a solution and/or suspension at room temperature. At higher concentrations of ZnR (e.g., about 70% or more), ZnR sources are typically solids at room temperature.

Preferably the ZnR source is a melt which contains 70 to 100 wt. % zinc ricinoleate; more preferably, the ZnR source contains 80 to 94 wt. % zinc ricinoleate; most preferably, the ZnR source contains 86 to 90 wt. % zinc ricinoleate, for example, about 88 wt. % zinc ricinoleate. The melt is combined with the other components of the detergent composition.

The C₂-C₅ polyol may be a mixture of glycerol and propylene glycol. In an embodiment the ethoxylated alcohol nonionic surfactant comprises a polyethylene glycol (PEG) modified fatty alcohol. For example, ethoxylated alcohol nonionic surfactant may have seven mol of ethoxylation per mol of surfactant. In some embodiments, the polyethylene fatty alcohol includes a saturated C₁₂-C₁₅ fatty alcohol.

The unit dose detergent may further include 1 to 5 wt. % of monoethanolamine.

The unit dose composition includes a third surfactant with a mean Hydrophilic-Lipophilic Balance (HLB) of 2 to 10. It has been unexpected discovered that incorporation of this third surfactant strongly increases stability of the zinc ricinoleate in the unit dose detergent product. Mean HLB is the weight average HLB of any constituent surfactants for mixtures.

The Hydrophilic-Lipophilic Balance (HLB) states the relative efficiency between the hydrophilic and the hydrophobic part of a surfactant. The higher the HLB, the more hydrophilic and the lower, the more hydrophobic. Detergents typically have HLB values between 13 and 15 such as linear akyl sulfates (LAS), non-ionic alcohol ethoxylates (AE), and alkyl-ether sulfates (AES). A HLB value of about 3 to 6 is typically used to create water-in-oil emulsions whereas an HLB between 8 and 16 forms oil-in-water emulsions. As such, when the unit dose composition additionally includes a surfactant with a mean HLB of 2 to 10, the unit dose composition contains both high HLB level (13-15) surfactant(s) (e.g., LAS, AES) and low HLB level (2-10) surfactant(s).

In an embodiment, the detergent formulation includes 1 to 10 wt. % of a surfactant with an HLB of 2 to 10. It is not clear where between HLB 8 and HLB 10 the transition in behavior from stability to instability occurs. In some embodiments, the surfactant has an HLB of 2 to 8, 2 to 6, 2 to 4, 4 to 10, 4 to 8, 4 to 6, 6 to 10, or 8 to 10. Such surfactant may be a non-ionic alkyl alkoxy sorbitan. Suitable surfactants may include SPAN′ 80 (i.e., sorbitane monooleate, sorbitan oleate); SPAN 85 (i.e., sorbitane trioleate), TWEEN™ 80 (i.e., POE (20) sorbitan monooleate, polyethylene glycol sorbitan monooleate, polyoxyethylenesorbitan monooleate, polysorbate 80); TWEEN 20 (i.e., polyethylene glycol sorbitan monolaurate, polyoxyethylenesorbitan monolaurate); and/or mixtures thereof.

This specification also describes a method of forming a detergent unit dose product containing zinc ricinoleate. The method includes melting a solid first composition (i.e., a solid zinc ricinoleate source), wherein the solid first composition includes 70 to 100 wt. % zinc ricinoleate. The method also includes combining the melted first composition with the other components of the formulation, wherein the other components of the formulation are, as percentages of the formulation by weight: 5 to 20 wt. % water; 5 to 25 wt. % of active alkali ethoxy alkyl sulfate(s); 10 to 25 wt. % of an ethoxylated alcohol nonionic surfactant; an amine; and 10 to 20 wt. % of a C₂-C₅ polyol.

The method may further include encapsulating the resulting combined mixture from the previous step in a pouch made from a water soluble polymer. Each pouch constitutes a single use detergent product, which typically has a weight from about 15 to about 30 grams, with about 0.3 to about 3 grams of zinc ricinoleate contained therein.

During the preparation of the detergent composition, before it is encapsulated in a pouch, it is most preferred to add the ZnR melt the last in the preparation. However, the ZnR melt may be premixed with the surfactants prior to being further mixed with the rest of the components in the detergent composition. To avoid the ZnR melt from being prematurely precipitated during the process, it is critical to make sure that there are sufficient amounts of surfactants to stabilize the ZnR melt. In other words, it is best that to stabilize the ZnR melt in an environment with sufficient surfactants, either by adding the ZnR melt to a surfactant solution, with or without the other components having already been pre-mixed with the surfactant solution, or by adding a surfactant solution to the ZnR melt, with or without the other components having been pre-mixed with the surfactant solution. The other components in the detergent composition can be added any time, as long as the ZnR melt is not mixed with the other components without surfactants present.

In an embodiment, Zinc ricinoleate (ZnR) makes up at between 0.2 and 5 wt. % of the formulation; preferably, the ZnR makes up between 0.5 and 4 wt. % of the formulation; more preferably, the ZnR makes up 1 to 3 wt. % of the formulation; and most preferably, the ZnR makes up 1.3 to 2.7 wt. % of the formulation. Preferably, the ZnR is added as a melt to the formulation from a solid composition that contains 70 to 100 wt. % ZnR; more preferably 80 to 94 wt. % ZnR; and most preferably 86 to 90 wt. % ZnR.

Stability of the formulation is further enhanced by adding a surfactant having an HLB of 2 to 10. It is not clear where the change in behavior between HLB 8 and HLB 10 lies. In some embodiments, the surfactant has an HLB of 2 to 8, 2 to 6, 2 to 4, 4 to 10, 4 to 8, 4 to 6, 6 to 10, or 8 to 10. In an embodiment, the surfactant having an HLB of 2 to 10 is added to the melt containing the zinc ricinoleate. In another embodiment, the zinc ricinoleate melt is added to the surfactant having an HLB of 2 to 10.

### BRIEF DESCRIPTION OF THE DRAWINGS

The accompanying drawing illustrates various embodiments of the principles described herein and is a part of the specification. The illustrated embodiments do not limit the scope of the claims.

FIG. 1 shows measures of sedimenting rate of 2.5 wt. % of zinc ricinoleate formulations containing 5 wt. % of additional surfactant with a mean Hydrophilic-Lipophilic Balance (HLB) ranging from 2 to 16.

FIG. 2 shows Separation Index measurements of a control, 1 wt. % HLB 6 surfactant, and 1 wt. % HLB 8 surfactant formulations which include zinc ricinoleate.

### DETAILED DESCRIPTION OF THE INVENTION

As used in this specification and the associated claims, organic molecules may be represented using the notation of the letter C followed by a number, e.g., C12. The number indicates the number of carbon atoms in the associated organic molecule. The identified organic molecules need not be hydrocarbons but may include substitutions, for example, C3 polyols would include both glycerin and propylene glycol, both of which have three carbons in their structure and multiple hydroxyl substitutions.

As used in this specification and the associated claims, a surfactant is a molecule with a hydrophilic domain and a hydrophobic (and/or lipophilic) domain. A surfactant may be anionic, cationic, zwitterionic (and/or amphoteric), or non-ionic. Generally speaking, the hydrophobic domain comprises 5 and/or more connected hydrocarbons without intervening polar substitutions. For references to mean HLB balances, the mean is a weight average mean. This may be calculated by summing the products of the weight percentages by the HLB value and dividing the sum by the total weight.

Zinc ricinoleate may be available in solution or suspension from commercial providers. These commercial solutions or suspensions may contain, for example, about 30 wt. % of zinc ricinoleate, with the other 70% being a proprietary mixture of water, surfactants, and other solvents. However, when these mixtures were used to form formulations with even 0.15 wt. % of the formulation was ZnR, the ZnR becomes unstable and settles out of solution.

For example, in attempting to develop a low water detergent formulation, it was found that the use of these solution based sources of zinc ricinolate resulted in precipitation/flocculation of the zinc ricinoleate from solution when mixed the other components of the detergent composition. Specifically, flocculation, precipitation, and/or sedimentation of ZnR was observed when the unit dose detergent composition contained over 0.15% by weight of ZnR from these commercially available 30 wt. % zinc ricinoleate solutions. This instability worsens when the temperature of the solutions is increased above room temperature.

However, it has been unexpectedly discovered that the instability of the ZnR in solution can be reduced by using solid ZnR material instead of liquid 30% active ZnR as a source of the ZnR in the detergent formulation. Solid ZnR material was not recommended by suppliers for use in preparing unit dose detergent compositions in liquid form because it is difficult to handle the solid form and because precipitation tends to occur during the manufacturing process when ZnR from the solid source is added to a detergent composition. Without wishing to be bound by theory, it is believed that ZnR in solid form has no or insufficient other components that could function as stabilizers, verses 30% of ZnR supplied in solution with 70% of other components which arguably function as stabilizers.

Higher concentration ZnR material tends to be available as a solid material and not as a liquid solution. Preferably, the solid ZnR material contains at least 70% wt. of ZnR; more preferably, the solid ZnR material contains at least 80 wt. % of ZnR; and most preferably, the solid ZnR material contains at least 88 wt. % of ZnR.

It was unexpectedly discovered that by melting solid ZnR material and then adding the ZnR melt to a detergent batch, the ZnR is much more stable in the unit dose formulation compared to using a similar amount of ZnR provided from 30% solutions. It is unclear why adding the ZnR in this manner produces superior stability in a detergent formulation.

In an embodiment, Zinc ricinoleate (ZnR) makes up at between 0.2 and 5 wt. % of the formulation; preferably, the ZnR makes up between 0.5 and 4 wt. % of the formulation; more preferably, the ZnR makes up 1 to 3 wt. % of the formulation; and most preferably, the ZnR makes up 1.3 to 2.7 wt. % of the formulation. The ZnR is added as a melt to the formulation from a solid composition that is at least 70 wt. % ZnR.

Unit dose detergent compositions may also include a variety of components including but not limited to: surfactants (anionic, cationic, non-ionic, zwitterionic and/or amphoteric), humectants, non-aqueous solvents, water, builders, complexers, chelators, enzymes, foam stabilizers, colorants, colorant stabilizers, optical brighteners, whitening agents, bittering agents, perfumes, and other optional components.

Surfactants: Useful surfactants in the liquid compositions of the present invention include, for example, an anionic surfactant, a nonionic surfactant, a cationic surfactant, an ampholytic surfactant, a zwitterionic surfactant, and/or mixtures thereof. The use of multiple surfactants of a particular type or a distribution of different weights of a surfactant may be particularly useful. The categories of surfactants will be discussed individually, below.

Anionic Surfactants:

Suitable anionic surfactants include but not limited to those surfactants that contain a long chain hydrocarbon hydrophobic group in their molecular structure and a hydrophilic group, i.e., water solubilizing group including salts such as carboxylate, sulfonate, sulfate, or phosphate groups. Suitable anionic surfactant salts include sodium, potassium, calcium, magnesium, barium, iron, ammonium and amine salts. Other suitable secondary anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group.

In one embodiment, the anionic surfactant is a polyethoxylated alcohol sulfate, such as those sold under the trade name CALFOAM® 303 (Pilot Chemical Company, California). Such materials, also known as alkyl-ether sulfates (AES) or alkyl polyethoxylate sulfates, are those which correspond to the following formula (I):

R′—O—(C₂H₄O)ₙ—SO₃M′ (I)

wherein R′ is a C₈-C₂₀ alkyl group, n is from 1 to 20, and M′ is a salt-forming cation; preferably, R′ is C₁₀-C₁₈ alkyl, n is from 1 to 15, and M′ is sodium, potassium, ammonium, alkylammonium, or alkanolammonium. In an embodiment, R′ is a C₁₂-C₁₆ alkyl, n is from 1 to 6 and M′ is sodium. In one preferred embodiment, the alkyl-ether sulfate has a C₁₂ alkyl chain, for example, sodium lauryl ether sulphate (SLES).

The alkyl-ether sulfates will generally be used in the form of mixtures comprising varying R′ chain lengths and varying degrees of ethoxylation. The heterogeneity of chain length may be due to the sourcing of the material and/or the processing of the material. Frequently such mixtures will inevitably also contain some unethoxylated alkyl sulfate materials, i.e., surfactants of the above ethoxylated alkyl sulfate formula wherein n=0. Unethoxylated alkyl sulfates may also be added separately to the liquid compositions of this invention. Suitable unalkoxylated, e.g., unethoxylated, alkyl-ether sulfate surfactants are those produced by the sulfation of higher C₈-C₂₀ fatty alcohols. Conventional primary alkyl sulfate surfactants have the general formula of: ROSO₃M, wherein R is typically a linear C₈-C₂₀ hydrocarbyl group, which may be straight chain or branched chain, and M is a water-solubilizing cation; preferably R is a C₁₀-C₁₅ alkyl, and M is alkali metal. In one embodiment, R is C₁₂-C₁₄ and M is sodium. Examples of other anionic surfactants are disclosed in U.S. Pat. No. 6,284,230, the disclosure of which is incorporated by reference herein.

The anionic surfactant may include a water-soluble salt of an alkyl benzene sulfonate having between 8 and 22 carbon atoms in the alkyl group. In one embodiment, the anionic surfactant comprises an alkali metal salt of C₁₀₋₁₆ alkyl benzene sulfonic acids, such as C₁₁₋₁₄ alkyl benzene sulfonic acids. In one embodiment, the alkyl group is linear and such linear alkyl benzene sulfonates are known in the art as “LAS.” Other suitable anionic surfactants include sodium and potassium linear, straight chain alkylbenzene sulfonates in which the average number of carbon atoms in the alkyl group is between 11 and 14. Sodium C₁₁-C₁₄, e.g., C₁₂, LAS are exemplary of suitable anionic surfactants for use herein.

In one embodiment, the anionic surfactant includes at least one α-sulfofatty acid ester. Such a sulfofatty acid is typically formed by esterifying a carboxylic acid with an alkanol and then sulfonating the α-position of the resulting ester. The α-sulfofatty acid ester is typically of the following formula (II):

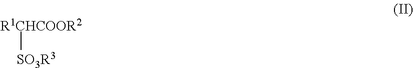

wherein R¹ is a linear or branched alkyl, R² is a linear or branched alkyl, and R³ is hydrogen, a halogen, a mono-valent or di-valent cation, or an unsubstituted or substituted ammonium cation. R¹ can be a C₄ to C₂₄ alkyl, including a C₁₀, C₁₂, C₁₄, C₁₆ and/or C₁₈ alkyl. R² can be a C₁ to C₈ alkyl, including a methyl group. R³ is typically a mono-valent or di-valent cation, such as a cation that forms a water soluble salt with the α-sulfofatty acid ester (e.g., an alkali metal salt such as sodium, potassium or lithium). The α-sulfofatty acid ester of formula (II) can be a methyl ester sulfonate, such as a C₁₆ methyl ester sulfonate, a C₁₈ methyl ester sulfonate, or a mixture thereof. In another embodiment, the α-sulfofatty acid ester of formula (II) can be a methyl ester sulfonate, such as a mixture of C₁₂-C₁₈ methyl ester sulfonates.

More typically, the α-sulfofatty acid ester is a salt, such as a salt according to the following formula (III):

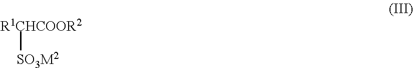

wherein R¹ and R² are linear or branched alkyls and M² is a monovalent metal. R¹ can be a C₄ to C₂₄ alkyl, including a C₁₀, C₁₂, C₁₄, C₁₆, and/or Cis alkyl. R² can be a C₁ to C₈ alkyl, including a methyl group. M² is typically an alkali metal, such as sodium or potassium. The α-sulfofatty acid ester of formula (III) can be a sodium methyl ester sulfonate, such as a sodium C_{8-C18} methyl ester sulfonate.

In one embodiment, the detergent composition contains about 5 wt. % to about 30 wt. % of one or more anionic surfactants, preferably about 8 wt. % to about 20 wt. %, more preferably about 10 wt. % to about 15 wt. %. In some embodiments, the anionic surfactant is provided in a solvent.

Suitable nonionic surfactants include but not limited to alkoxylated fatty alcohols, ethylene oxide (EO)-propylene oxide (PO) block polymers, and amine oxide surfactants. Suitable for use in the liquid compositions herein are those nonionic surfactants which are normally liquid. Suitable nonionic surfactants for use herein include the alcohol alkoxylated nonionic surfactants. Alcohol alkoxylates are materials which correspond to the general formula of: R⁹(CₘH₂ₘO)ₙOH, wherein R⁹ is a linear or branched C_{8-C18} alkyl group, m is from 2 to 4, and n ranges from 2 to 12; alternatively R⁹ is a linear or branched C₉₋₁₅ or C₁₀₋₁₄ alkyl group. In another embodiment, the alkoxylated fatty alcohols will be ethoxylated materials that contain from 2 to 12, or 3 to 10, ethylene oxide (EO) moieties per molecule. The alkoxylated fatty alcohol materials useful in the liquid compositions herein will frequently have a hydrophilic-lipophilic balance (HLB) which ranges from 3 to 17, from 6 to 15, or from 8 to 15. Alkoxylated fatty alcohol nonionic surfactants have been marketed under the tradenames Neodol and Dobanol by the Shell Chemical Company. Another nonionic surfactant suitable for use includes ethylene oxide (EO)-propylene oxide (PO) block polymers, such as those marketed under the tradename Pluronic. These materials are formed by adding blocks of ethylene oxide moieties to the ends of polypropylene glycol chains to adjust the surface active properties of the resulting block polymers. In one embodiment, the nonionic surfactant is C₁₂-C₁₅ alcohol ethoxylate 7EO, that is to say having seven ethylene oxide moieties (repeat units) per molecule. The fatty alcohol ethoxylate may have 3 to 17 moles of ethylene oxide units per mole of fatty alcohol ethoxylate.

Another embodiment of a nonionic surfactant is alkoxylated, preferably ethoxylated or ethoxylated and propoxylated fatty acid alkyl esters, having from 1 to 4 carbon atoms in the alkyl chain, especially fatty acid methyl esters, as described, for example, in JP58/217598, which is incorporated by reference herein. In one embodiment, the nonionic surfactant is methyl ester ethoxylate.

Suitable nonionic surfactants also include polyalkoxylated alkanolamides, which are generally of the following formula (IV):

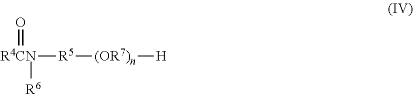

wherein R⁴ is an alkyl or alkoxy, R⁵ and R⁷ are alkyls and n is a positive integer. R⁴ is typically an alkyl containing 6 to 22 carbon atoms. R⁵ is typically an alkyl containing 1-8 carbon atoms. R⁷ is typically an alkyl containing 1 to 4 carbon atoms, and more typically an ethyl group. The degree of polyalkoxylation (the molar ratio of the oxyalkyl groups per mole of alkanolamide) typically ranges from about 1 to about 100, or from about 3 to about 8, or about 5 to about 6. R⁶ can be hydrogen, an alkyl, an alkoxy group or a polyalkoxylated alkyl. The polyalkoxylated alkanolamide is typically a polyalkoxylated mono- or di-alkanolamide, such as a C₁₆ and/or C₁₅ ethoxylated monoalkanolamide, or an ethoxylated monoalkanolamide prepared from palm kernel oil or coconut oil. The use of coconut oil, palm oil, and similar naturally occurring oils as precursors may be favored by consumers.

Other suitable nonionic surfactants include those containing an organic hydrophobic group and a hydrophilic group that is a reaction product of a solubilizing group (such as a carboxylate, hydroxyl, amido or amino group) with an alkylating agent, such as ethylene oxide, propylene oxide, or a polyhydration product thereof (such as polyethylene glycol). Such nonionic surfactants include, for example, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, and alkylamine oxides. Other suitable surfactants include those disclosed in U.S. Pat. Nos. 5,945,394 and 6,046,149, the disclosures of which are incorporated herein by reference. In another embodiment, the composition is substantially free of nonylphenol nonionic surfactants. In this context, the term “substantially free” means less than about one weight percent.

Yet another nonionic surfactant useful herein comprises amine oxide surfactants. Amine oxides are often referred to in the art as “semi-polar” nonionics, and have the following formula (V):

R¹⁰(EO)ₓ(PO)_{y}(BO)_{z}N(O)(CH₂R¹¹)₂.qH₂O (V)

wherein R¹⁰ is a hydrocarbyl moiety which can be saturated or unsaturated, linear or branched, and can typically contain from 8 to 24, from 10 to 16 carbon atoms, or a C₁₂-C₁₆ primary alkyl. R11 is a short-chain moiety such as a hydrogen, methyl and —CH₂OH. When x+y+z is greater than 0, EO is ethyleneoxy, PO is propyleneoxy and BO is butyleneoxy. In this formula, q is the number of water molecules in the surfactant. In one embodiment, the nonionic surfactant is C₂₋₁₄ alkyldimethyl amine oxide.

In one embodiment, the detergent composition includes about 15 wt. % to about 40 wt. % of one or more nonionic surfactants, preferably about 18 wt. % to about 30 wt. %, more preferably about 20 wt. % to about 25 wt. %.

Zwitterionic and/or Amphoteric Surfactants:

Suitable zwitterionic and/or amphoteric surfactants include but not limited to derivatives of secondary and tertiary amines, derivatives of heterocyclic secondary and tertiary amines, or derivatives of quaternary ammonium, quaternary phosphonium or tertiary sulfonium compounds, such as those disclosed in U.S. Pat. No. 3,929,678, which is incorporated by reference herein.

Suitable zwitterionic and/or amphoteric surfactants for uses herein include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group. When present, zwitterionic and/or amphoteric surfactants typically constitute from 0.01 wt. % to 20 wt. %, preferably, from 0.5 wt. % to 10 wt. %, and most preferably 2 wt. % to 5 wt. % of the formulation by weight.

Cationic Surfactants:

Suitable cationic surfactants include but not limited to quaternary ammonium surfactants. Suitable quaternary ammonium surfactants include mono C₆-C₁₆, or C₆-C₁₀ N-alkyl or alkenyl ammonium surfactants, wherein the remaining N positions are substituted by, e.g., methyl, hydroxyethyl or hydroxypropyl groups. Another cationic surfactant is C₆-C₁₅ alkyl or alkenyl ester of a quaternary ammonium alcohol, such as quaternary chlorine esters. In another embodiment, the cationic surfactants have the following formula (VI):

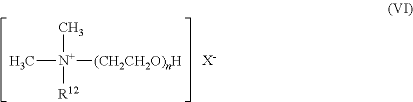

wherein R¹² is C₈-C₁₈ hydrocarbyl and mixtures thereof, or C₈₋₁₄ alkyl, or C₈, C₁₀, or C₁₂ alkyl, X is an anion such as chloride or bromide, and n is a positive integer.

In one embodiment, the surfactant of the liquid composition of the invention comprises an anionic surfactant, a nonionic surfactant, or mixtures thereof. In another embodiment, the anionic surfactant is alkyl benzene sulfonic acid, methyl ester sulfate, sodium lauryl ether sulfate, or mixtures thereof. In another embodiment, the nonionic surfactant is alcohol ethoxylate, methyl ester ethoxylate, or mixtures thereof.

The surfactants may be a mixture of at least one anionic and at least one nonionic surfactant. In another embodiment, the anionic surfactant is sodium lauryl ether sulfate. In another embodiment, the surfactant is a mixture of at least two anionic surfactants. In one embodiment, the surfactant comprises a mixture of an alkyl benzene sulfonate and an alkyl-ether sulfate. In another embodiment, and the alkyl-ether sulfate is sodium lauryl ether sulphate (SLES).

In certain embodiments, the surfactant comprises about 15 wt. % to about 30 wt. % of an anionic surfactant selected from the group consisting of alkyl benzene sulfonate, methyl ester sulfonate, sodium lauryl ether sulphate, and mixtures thereof, and about 15 wt. % to about 30 wt. % of an nonionic surfactant selected from the group consisting of alcohol ethoxylate, methyl ester ethoxylate, and mixtures thereof. Surfactants may collectively total more than 30 wt. % of the formulation. Surfactants are often the base of detergent compositions, however, other components, such as solvents and humectants may be used to make a liquid formulation rather than a solid formulation.

In an embodiment, the unit dose detergent composition includes an alkyl-ether sulfate, a linear alkylbenzene sulfonate, and a fatty alcohol ethoxylate. These three materials may collectively make up no less than 30% of the formulation.

In an embodiment, an alkyl-ether sulfate makes up 5 wt. % to about 30 wt. %, preferably about 8 wt. % to about 20 wt. %, and more preferably about 10 wt. % to about 15 wt. % of the detergent composition. A fatty alcohol ethoxylate may makes up about 15 wt. % to about 40 wt., preferably about 18 wt. % to about 30 wt. %, and more preferably about 20 wt. % to about 25 wt. % of the detergent composition. A linear alkyl benzene sulfonate may make up about 1 wt. % to about 12 wt. %, preferably about 2 wt. % to about 8 wt. %, and most preferably, about 4 wt. % to about 6 wt. % of the detergent composition. In some preferred embodiments, the alkyl-ether sulfate, the linear alkyl benzene sulfonate, and the fatty alcohol ethoxylate may be present in a ratio of (2 to 5):1:(3 to 10); preferably in a ratio of (2.5 to 3.5):1:(4 to 6); and most preferably in a ratio of approximately 3:1:5.

Humectants:

A humectant, for purposes of the present invention, is a substance that exhibits high affinity for water, especially attracting water for moisturization and solubilization purposes. The water is absorbed into the humectant; not merely adsorbed at a surface layer. The water absorbed by the humectant is available to the system; the water is not too tightly bound to the humectant. For example, in a skin lotion, the humectant attracts moisture from the surrounding atmosphere while reducing transepidermal water loss, and makes the water available to the skin barrier. Similarly, the humectant in a single dose liquid formula will not trap all the water needed for solubilization of other formula components—it will help to maintain the water balance between the formula, the film, and the atmosphere. Humectants possess hydrophilic groups which form hydrogen bonds with water. Common hydrophilic groups include hydroxyl, carboxyl, ester, and amine functionalities. A humectant can thus act as a solubilizer and moisture regulator in a unit dose formulation. Useful humectants include but not limited to polyols.

The polyol (or polyhydric alcohol) may be a linear or branched alcohol with two or more hydroxyl groups. Thus diols with two hydroxyl groups attached to separate carbon atoms in an aliphatic chain may also be used. The polyol typically includes less than 9 carbon atoms, such as 9, 8, 7, 6, 5, 4, 3, or 2 carbon atoms. Preferably, the polyol includes 3 to 8 carbon atoms. More preferably, the polyol includes 3 to 6 carbon atoms. The molecular weight is typically less than 500 g/mol, such as less than 400 g/mol or less than 300 g/mol.

Embodiments of suitable polyols include, but not limited to: propylene glycol, butylene glycol, pentylene glycol, hexylene glycol, heptylene glycol, octylene glycol, 2-methyl-1,3-propanediol, xylitol, sorbitol, mannitol, diethylene glycol, triethylene glycol, glycerol, erythritol, dulcitol, inositol, and adonitol.

The unit dose detergent compositions of the present invention may contain about 5 wt. % to about 75 wt. % of one or more humectants, preferably about 7 wt. % to about 50 w.t %, more preferably about 10 wt. % to about 40 wt. %. In one preferred embodiment, the liquid composition comprises 10 to 20 wt. % of one or more C₂ to C₅ polyols. Preferably, the C₂ to C₅ polyols comprise a mixture of glycerine and propylene glycol, where the ratio of glycerine to propylene glycol is from 2:1 to 1:2. The liquid composition may be substantially free of monoalcohols, for example, the composition may comprise less than 1 wt. % of monoalcohols.

The unit dose detergent compositions of the present invention may optionally comprise other ingredients that can typically be present in detergent products and/or personal care products to provide further benefits in terms of cleaning power, solubilization, appearance, fragrance, etc. Different groups of such materials are described below.

Water:

Water functions as a solvent and viscosity modifier. Water may be present as 5 to 30 wt. % of the unit dose detergent composition. Water may be present as 10 to 20 wt. % of the unit dose detergent composition.

Builders:

Other suitable components include organic or inorganic detergency builders. Examples of water-soluble inorganic builders that can be used, either alone or in combination with themselves or with organic alkaline sequestrant builder salts, are glycine, alkyl and alkenyl succinates, alkali metal carbonates, alkali metal bicarbonates, phosphates, polyphosphates and silicates. Specific examples of such salts are sodium tripolyphosphate, sodium carbonate, potassium carbonate, sodium bicarbonate, potassium bicarbonate, sodium pyrophosphate and potassium pyrophosphate. Examples of organic builder salts that can be used alone, or in combination with each other, or with the preceding inorganic alkaline builder salts, are alkali metal polycarboxylates, water-soluble citrates such as sodium and potassium citrate, sodium and potassium tartrate, sodium and potassium ethylenediaminetetracetate (EDTA), sodium and potassium N(2-hydroxyethyl)-nitrilo triacetates, sodium and potassium N-(2-hydroxyethyl)-nitrilo diacetates, sodium and potassium oxydisuccinates, and sodium and potassium tartrate mono- and di-succinates, such as those described in U.S. Pat. No. 4,663,071, the disclosure of which is incorporated herein by reference.

Complexer/Chelator:

Complexer and chelators help washing liquids support higher amounts of soils and/or metal ions. Complexer and/or chelators may functionally overlap with builders as discussed above. These are often poly carboxylic acids and/or salts thereof. Polyamines also may be used in this role. Suitable examples include iminodisuccinic acid, succinic acid, citric acid, ethylenediaminetetraacetic acid, etc. A complexer and/or chelator may make up about 0 to about 5 wt. % of the formulation, preferably about 0.1 to about 3 wt. % of the formulation, and most preferably about 0.5 to about 2 wt. % of the detergent composition.

Enzymes:

Suitable enzymes include those known in the art, such as amylolytic, proteolytic, cellulolytic or lipolytic type, and those listed in U.S. Pat. No. 5,958,864, the disclosure of which is incorporated herein by reference. One protease, sold under the trade name SAVINASE® by Novozymes A/S, is a subtillase from Bacillus lentus. Other suitable enzymes include proteases, amylases, lipases and cellulases, such as ALCALASE® (bacterial protease), EVERLASE® (protein-engineered variant of SAVINASEO), ESPERASE® (bacterial protease), LIPOLASE® (fungal lipase), LIPOLASE ULTRA (Protein-engineered variant of LIPOLASE), LIPOPRIME® (protein-engineered variant of LIPOLASE), TERMAMYL® (bacterial amylase), BAN (Bacterial Amylase Novo), CELLUZYME® (fungal enzyme), and CAREZYME® (monocomponent cellulase). Additional enzymes of these classes suitable for use in accordance with the present invention will be well-known to those of ordinary skill in the art, and are available from a variety of commercial suppliers. Enzymes maybe provided with other components, including stabilizers. In an embodiment, the enzyme material may be approximately 10% by weight active enzymes. The detergent composition may include about 0.01 to about 1.3 wt. %, preferably, 0.05 to 0.50 wt. %, and most preferably, about 0.08 to about 0.3 wt. % of active enzymes.

Foam Stabilizers:

Foam stabilizing agents include, but not limited to, a polyalkoxylated alkanolamide, amide, amine oxide, betaine, sultaine, C8-C18 fatty alcohols, and those disclosed in U.S. Pat. No. 5,616,781, the disclosure of which is incorporated by reference herein. Foam stabilizing agents are used, for example, in amounts of about 1 wt. % to about 20 wt. %, and typically about 3. wt. % to about 5 wt. %. The composition can further include an auxiliary foam stabilizing surfactant, such as a fatty acid amide surfactant. Suitable fatty acid amides are C8-C20 alkanol amides, monoethanolamides, diethanolamides, and isopropanolamides.

Colorants: In some embodiments, the liquid composition does not contain a colorant. In some embodiments, the liquid composition contains one or more colorants. The colorant(s) can be, for example, polymers. The colorant(s) can be, for example, dyes. The colorant(s) can be, for example, water-soluble polymeric colorants. The colorant(s) can be, for example, water-soluble dyes. The colorant(s) can be, for example, colorants that are well-known in the art or commercially available from dye or chemical manufacturers.

The color of the colorant(s) is not limited, and can be, for example, red, orange, yellow, blue, indigo, violet, or any combination thereof. The colorant(s) can be, for example, one or more Milliken LIQUITINT colorants. The colorant(s) can be, for example Milliken LIQUITINT: VIOLET LS, ROYAL MC, BLUE HP, BLUE MC, AQUAMARINE, GREEN HMC, BRIGHT YELLOW, YELLOW LP, YELLOW BL, BRILLIANT ORANGE, CRIMSON, RED MX, PINK AL, RED BL, RED ST, or any combination thereof.

The colorant(s) can be, for example, one or more of Acid Blue 80, Acid Red 52, and Acid Violet 48. When the colorant(s) are selected from the group consisting of Acid Blue 80, Acid Red 52, and Acid Violet 48, the liquid composition, optionally, does not contain a colorant stabilizer. Surprisingly, it has been found that Acid Blue 80, Acid Red 52, and Acid Violet 48, do not display significant discoloration over time, and thus, can be used without (e.g., in the absence of) a colorant stabilizer.

The colorant may provide a secondary indicator of source for a user. The colorant may provide aesthetic or informational value. For example, the color of the detergent composition may be used to indicate a preferred water temperature (e.g., red for hot, blue for cold).

The total amount of the one or more colorant(s) that can be contained in the liquid composition, for example, can range from about 0.00001 wt. % to about 0.099 wt. %. The total amount of colorant(s) in the liquid composition can be, for example, about 0.0001 wt. %, about 0.001 wt. %, about 0.01 wt. %, about 0.05 wt. %, or about 0.08 wt. %.

Colorant Stabilizer(s):

In some embodiments, the liquid composition can optionally contain a colorant stabilizer. In some embodiments, the colorant stabilizer can be citric acid. The total amount of the optionally present colorant stabilizer(s) in the liquid composition can range, for example, from about 0.01 wt. % to about 5.0 wt. %. The total amount of the colorant stabilizer(s) in the liquid composition can be, for example, about 0.1 wt. %, about 1 wt. %, about 2 wt. %, about 3 wt. %, or about 4 wt. %.

Optical Brightener/Whitening Agents:

Optical brighteners and/or whitening agents help washed material appear white, especially under florescent light. The particular whitening agent is not believed to be impactful to the shelf stability of the formulations. Whitening agents may be complex, polycyclic molecules. Examples of whitening agents include: 4,4′-diamino-2,2′-stilbenedisulfonic acid and 2,5-bis(benzoxazol-2-yl)thiophene. The substitution of similar whitening agents and/or reasonable modifications of their concentration in the formulation should produce similar results. An optical brightener and/or whitening agent may make up about 0 to about 5 wt. % of the formulation, preferably about 0.1 to about 3 wt. % of the formulation, and most preferably about 0.5 to about 2 wt. % of the detergent composition.

Bittering Agent:

Bittering agents may optionally be added to hinder accidental ingestion of the composition. Bittering agents are compositions that taste bad, so children and/or others are discouraged from accidental ingestion. Exemplary bittering agents include denatonium benzoate, aloin, and others. Denatonium is available under a variety of trade names including: BITTERANT-b, BITTER+PLUS, Bitrex, and/or Aversion. Bittering agents may be present in the composition at an amount of from about 0 to about 1 wt. %, preferably from about 0 to about 0.5 wt. %, and most preferably from about 0 to about 0.1 wt. %, based on the total weight of the detergent composition.

Perfumes:

The liquid compositions of the invention may optionally include one or more perfumes or fragrances. As used herein, the term “perfume” is used in its ordinary sense to refer to and include any fragrant substance or mixture of substances including natural (obtained by extraction of flowers, herbs, leaves, roots, barks, wood, blossoms or plants), artificial (mixture of natural oils or oil constituents) and synthetically produced odoriferous substances. Typically, perfumes are complex mixtures of blends of various organic compounds such as alcohols, aldehydes, ethers, aromatic compounds and varying amounts of essential oils (e.g., terpenes) such as from 0 wt. % to 80 wt. %, usually from 1 wt. % to 70 wt. %, the essential oils themselves being volatile odoriferous compounds and also serving to dissolve the other components of the perfume. Suitable perfume ingredients include those disclosed in “Perfume and Flavour Chemicals (Aroma Chemicals)”, published by Steffen Arctander (1969), which is incorporated herein by reference. Perfumes can be present from about 0.1 wt. % to about 10 wt. %, and preferably from about 0.5 wt. % to about 5 wt. % of the detergent composition.

Other Optional Ingredients:

The liquid compositions may also contain one or more optional ingredients conventionally included in detergent compositions such as a pH buffering agent, a perfume carrier, a fluorescer, a hydrotrope, an antifoaming agent, an antiredeposition agent, a polyelectrolyte, an optical brightening agent, a pearlescer, an anti-shrinking agent, an anti-wrinkle agent, an anti-spotting agent, an anti-corrosion agent, a drape imparting agent, an anti-static agent, an ironing aids crystal growth inhibitor, an anti-oxidant, an anti-reducing agent, a chelating agent, a dispersing agent, a defoamer, a color component, a fragrance component, a bleaching catalyst, a bleaching agent, a bleach activator, a whitening agent, a brightening agent, an anticorrosion agent, a deodorizing agent, a color/texture rejuvenating agent, a soil releasing polymer, a preservative, a bittering agent, and a mixture thereof. Examples and sources of suitable such components are well-known in the art and/or are described herein. For example, a preferred bittering agent is denatonium benzoate, sold under the tradename Bitrex® (Johnson Matthey).

Water-Soluble Container/Pouch:

The unit dose detergent compositions of the present invention may be placed a water-soluble container. The water soluble container is made from a water-soluble material which dissolves, ruptures, disperses, or disintegrates upon contact with water, releasing thereby the liquid composition. In one embodiment, the water soluble container is made from a lower molecular weight water-soluble polyvinyl alcohol film-forming resin.

The water soluble container may be formed from a water soluble polymer selected from the group consisting of polyvinyl alcohol (PVA), polyvinyl pyrrolidone, polyalkylene oxide, polyacrylamide, poly acrylic acid, cellulose, cellulose ether, cellulose ester, cellulose amide, polyvinyl acetate, polycarboxylic acid and salt, polyaminoacid, polyamide, polyanhydride copolymer of maleic/acrylic acid, polysaccharide, natural gums, polyacrylate, water-soluble acrylate copolymer, methylcellulose, carboxymethylcellulose sodium, dextrin, ethylcellulose, hydroxyethyl cellulose, maltodextrin, polymethacrylate, polyvinyl alcohol copolymer, hydroxypropyl methyl cellulose (HPMC), and mixtures thereof.

Unit dose containers and methods of manufacture thereof that are suitable for use with the compositions of the present invention include those described, for example, in U.S. Pat. Nos. 3,218,776; 4,776,455; 4,973,416; 6,479,448; 6,727,215; 6,878,679; 7,259,134; 7,282,472; 7,304,025; 7,329,441; 7,439,215; 7,464,519; 7,595,290; 8,551,929; the disclosures of all of which are incorporated herein by reference in their entireties. In some embodiments, the container is a water-soluble, single-chamber container, prepared from a water-soluble film. According to one such aspect of the invention, the single-chamber container is a formed, sealed pouch produced from a water-soluble polymer or film such as polyvinylalcohol (PVA) or a PVA film.

Preferred water soluble polymers for forming the pouch are polyvinyl alcohol (PVA) resins sold under tradename MONOSOL® (MonoSol LLC, Indiana). The preferred grade is MONOSOL® film having a weight average molecular weight range of about 55,000 to 65,000 and a number average molecular weight range of about 27,000 to 33,000. Preferably, the film material will have a thickness of approximately 3 mil or 75 micrometers. Alternatively, commercial grade PVA films are suitable for use in the present invention, such as those that are commercially available from Monosol (Merrillville, Ind.) (e.g., Monosol film M8310) or from Aicello (Aiichi, Japan; North American subsidiary in North Vancouver, BC, Canada) (e.g., Aicello GA or Aicello GS).

In various embodiments, the film is desirably strong, flexible, shock resistant, and non-tacky during storage at both high and low temperatures and high and low humidities. In one embodiment, the film is initially formed from polyvinyl acetate, and at least a portion of the acetate functional groups are hydrolyzed to produce alcohol groups. The film may include polyvinyl alcohol (PVOH), and may include a higher concentration of PVOH than polyvinyl acetate. Such films are commercially available with various levels of hydrolysis, and thus various concentrations of PVOH, and in an exemplary embodiment the film initially has about 85 percent of the acetate groups hydrolyzed to alcohol groups. Some of the acetate groups may further hydrolyze in use, so the final concentration of alcohol groups may be higher than the concentration at the time of packaging. The film may have a thickness of from about 25 to about 200 micrometers (μm), or from about 45 to about 100 μm, or from about 75 to about 90 μm in various embodiments.

In some embodiments, the water soluble container further comprises a cross-linking agent. In some embodiments, the cross-linking agent is selected from the group consisting of formaldehyde, polyesters, epoxides, isocyanates, vinyl esters, urethanes, polyimides, acrylics with hydroxyl, carboxylic, isocyanate or activated ester groups, bis(methacryloxypropyl)tetramethylsiloxane (styrenes, methylmethacrylates), n-diazopyruvates, phenylboronic acids, cis-platin, divinylbenzene (styrenes, double bonds), polyamides, dialdehydes, triallyl cyanurates, N-(2-ethanesulfonylethyl) pyridinium halides, tetraalkyltitanates, titanates, borates, zirconates, or mixtures thereof. In one embodiment, the cross-linking agent is boric acid or a boric acid salt such as sodium borate.

In additional embodiments, the water-soluble container or film from which it is made can contain one or more additional components, agents or features, such as one or more perfumes or fragrances, one or more enzymes, one or more surfactants, one or more rinse agents, one or more dyes, one or more functional or aesthetic particles, and the like. Such components, agents or features can be incorporate into or on the film when it is manufactured, or are conveniently introduced onto the film during the process of manufacturing the liquid composition of the present invention, using methods that are known in the film-producing arts.

The water-soluble container (e.g., pouch) used in association with the present invention may be in any desirable shape and size and may be prepared in any suitable way, such as via molding, casting, extruding or blowing, and is then filled using an automated filling process. Examples of processes for producing and filling water-soluble containers, suitable for use in accordance with the present invention, are described in U.S. Pat. Nos. 3,218,776; 3,453,779; 4,776,455; 5,699,653; 5,722,217; 6,037,319; 6,727,215; 6,878,679; 7,259,134; 7,282,472; 7,304,025; 7,329,441; 7,439,215; 7,464,519; and 7,595,290; the disclosures of all of which are incorporated herein by reference in their entireties. In preferred embodiments, the pouches are filled with the liquid composition of the present invention using the cavity filling approach described in U.S. Pat. Nos. 3,218,776 and 4,776,455.

### EXAMPLES

### Example 1

TABLE 1

| | | Inventive | Control | Control | Control |
|---|---|---|---|---|---|
| Component | Activity | 1 | 2 | 3 | 4 |
| Glycerine | 99+% | 12.6 | 9.1 | 9.1 | 9.1 |
| C₁₂-C₁₄ Alcohol | 99+% | 23 | 23 | 23 | 23 |
| Ethoxylate 7EO | | | | | |
| Propylene Glycol | 99+% | 5 | 5 | 5 | 5 |
| Monoethanolamine | 99+% | 3.15 | 3.15 | 3.15 | 3.15 |
| Water | 100% | 3.6 | 3.6 | 3.6 | 3.6 |
| 2-Phenyl Sulfonic | 99+% | 5 | 5 | 5 | 5 |
| Acid | | | | | |
| Coconut Oil Fatty | 99+% | 10 | 10 | 10 | 10 |
| Acid | | | | | |
| Sodium C₁₂-C₁₄ | 60% | 26 | 26 | 26 | 26 |
| Alcohol Ethoxysulfate | | | | | |
| Bittering Agent | 25% | 0.05 | 0.05 | 0.05 | 0.05 |
| Enzyme | 10% | 2.5 | 2.5 | 2.5 | 2.5 |
| Whitening Agent | 100% | 0.2 | 0.2 | 0.2 | 0.2 |
| Polyethoxylated | 80% | 6 | 6 | 6 | 6 |
| PEI | | | | | |
| Sodium Sulfite | 15% | 1.33 | 1.33 | 1.33 | 1.33 |
| 15% solution | | | | | |
| ZnR Liquid 1 | 30% | n/a | 5 | n/a | n/a |
| 30% Active | | | | | |
| ZnR Liquid 2 | 30% | n/a | n/a | 5 | n/a |
| 30% Active | | | | | |
| ZnR Liquid 3 | 30% | n/a | n/a | n/a | 5 |
| 30% Active | | | | | |
| ZnR Solid | 88% | 1.5 | n/a | n/a | n/a |
| 88% Active | | | | | |

Table 1 shows an inventive composition labeled “Inventive 1” as well as 3 control compositions labeled “Control 2”, “Control 3”, and “Control 4” respectively. In Inventive 1, the ZnR is provided as a melt when mixed with the other components. Controls 5 to 7 were also run with 0.5, 1.5, and 2.5 wt. % of ZnR Liquid 2 and 4.5, 3.5, and 2.5 wt. % additional glycerine respectively. These showed similar behavior to the other control formulations. In the Control compositions, the ZnR is provided as different 30 wt. % active ZnR solutions purchased from commercial suppliers.

Inventive 1, Control 2, Control 3, and Control 4 were subjected to a stability tests documented in Table 2. In the sedimentation test, jars of the four detergent compositions were placed in environmental chambers at 41° C. (105° F.), 45° C. (113° F.), and 52° C. (125° F.). All control formulations had sedimentation within 12 hours. In contrast, the Inventive 1 formulation produced from a melt of ZnR did not have sedimentation at 12 hours at any of the tested temperatures. Separation Index measurements were made for Inventive 1, Control 2, and Control 3 at 4 and 8 hours. The Separation Index refers to the number generated by the LUMiSizer® instrument. The Separation Index number ranges from 0 to 1, with 0 being no separation (i.e., no instability) and 1 being complete separation (i.e., no stability). The LUMiSizer® determines instability by determining the difference in light transmission throughout the sample vial at time zero to the end of the test. The instrument compares transparency value differences to determine overall instability.

To measure the Separation Index, 400 microliters of each test solution was placed in a 2 mm polyamide cell (made by LUM, #110-134). The cells were loaded into the LUMiSizer® instrument and spun at 2500 rpm (˜880 g-force) for approximately 1000 minutes at 25° C. (75° F.) with a light factor of 1. Using LUM's SEPview® program, the Separation Index was calculated. Furthermore, a velocity of the particles can be calculated from the SEPview® program, which is based off the clarification rate of the sample over time (a slower clarification rate means that particles are separating slower and have a slower velocity).

A LUMiSizer® was used to measure the Separation Index for samples Inventive 1, Control 2, and Control 3. Control 4 was too precipitated to be effectively tested. The three tested formulations were spun at 2500 rpm (approximately 880 g-force) at and measurements of the separation index were taken at 4 and 8 hours. The results are available in Table 2, below. The separation index of the Inventive 1 formulation at 8 hours was 0.05 or 5% separated. In contrast, the separation for Control 2 was 0.64 or 64% separated and for Control 3 was 0.80 or 80% separated. Accordingly, despite the chemical similarities between the Inventive 1 formulation and the controls, a strong difference in stability of the ZnR was observed with the Inventive 1 solution being measurably more stable than Controls 2 and/or Control 3.

TABLE 2

| | Inventive | Control | Control | Control |
|---|---|---|---|---|
| Stability Test | 1 | 2 | 3 | 4 |
| Sedimentation within | No | Yes | Yes | Yes |
| 12 hours at 41° C. | | | | |
| Sedimentation within | No | Yes | Yes | Yes |
| 12 hours at 45° C. | | | | |
| Sedimentation within | No | Yes | Yes | Yes |
| 12 hours at 52° C. | | | | |
| Separation Index after | 0.03 | 0.30 | 0.64 | Not stable |
| 4 hours | | | | enough to test |
| Separation Index after | 0.05 | 0.64 | 0.80 | Not stable |
| 8 hours | | | | enough to test |

### Example 2

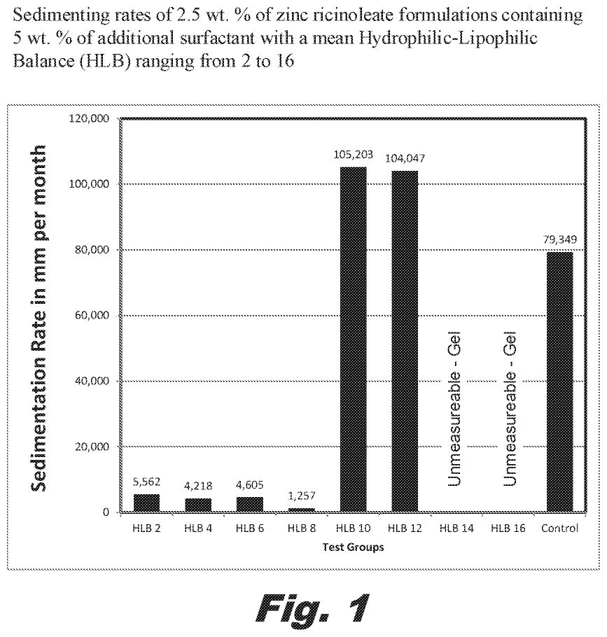

Attempting to understand the relationship between the surfactants and the stability of the ZnR in solution, it was unexpectedly discovered that the inclusion of 1 wt. % a surfactant with an HLB between 2 and 8 improved the stability of the ZnR even in the presence of other surfactants with HLBs from 10 to 16. As the detergent formulations often contain surfactants in the 10 to 16 HLB range, this discovery provided a reliable way to stabilize ZnR in the presence of the other detergent components allowing the formation of a detergent formulation at 1 wt. % ZnR and the desired surfactants. Data from this testing is shown in FIG. 1 and Table 4.

The stability of the ZnR in unit dose detergent formulations can be increased by adding a surfactant with an HLB around 2, 4, 6 or 8. The added surfactant has been shown effective when present as at least 1 wt. % of the unit dose formulation. Surfactants with HLBs 10 to 16 were not effective in stabilizing the ZnR. Surfactants with HLBs of 10 to 16 are frequent components in mixtures of detergents for washing applications. The unit dose formulation contains such surfactants. Accordingly, the addition of a surfactant with an HLB of 2 to 8 appears to stabilize the ZnR in the presence of surfactants with HLBs of 10 to 16.

The surfactants with different HLBs were tested up to 5 wt. % of the formulation. The surfactants with HLBs of 8 or lower included nonionic surfactants such as polyethylene glycol sorbitan monostearate (TWEEN 80) and/or PEG-20 sorbitan monolaurate (TWEEN 20), sorbitan oleate (SPAN 80), or mixtures thereof. In an embodiment, the lower HLB surfactant includes an alkylated sugar unit. The lower HLB surfactant may include polyglycol substitution(s). Example surfactants include SPAN 80, SPAN 85, TWEEN 80, and TWEEN 20. Non-ionic surfactants are well suited to this task due to the ability to create mixtures of multiple non-ionic surfactants with different numbers of glycol units and different sized alkyl regions to support the desired properties. Some of the HLBs were formed from mixtures of different surfactants to produce the desired mean HLB. For example a 50/50 blend (wt. basis) of an HLB 2 and an HLB 8 surfactant will be a surfactant mixture with an HLB of 5.

Specifically, HLB 2 was 8% SPAN 80 and 92% SPAN 85; HLB 4 was 88% SPAN 80 and 12% SPAN 85; HLB 6 was 83% SPAN 80 and 17% TWEEN 80; HLB 8 was 65% SPAN 80 and 35% TWEEN 80; HLB 10 was 46% SPAN 80 and 54% TWEEN 80; HLB 12 was 28% SPAN 80 and 72% TWEEN 80; HLB 14 was 9% SPAN 80 and 91% TWEEN 80; and HLB 16 was 60% TWEEN 20 and 40% TWEEN 80. The control had 5% more glycerine in place of the surfactant. The HLB surfactants additives were tested over a range of concentrations. The results in FIG. 1 and discussed below contain 2.5 wt. % of 88% active ZnR and 5 wt. % of the respective HLB surfactant mixture.

TABLE 3

| Material | Activity | Wt. % |
|---|---|---|
| Glycerine | 99+% | 6.6 |
| C₁₂-C₁₄ Alcohol Ethoxylate 7EO | 99+% | 23 |
| Propylene Glycol | 99+% | 5 |
| Monoethanolamine | 99+% | 3.15 |
| Water | 100% | 3.6 |
| 2-Phenyl Sulfonic Acid | 99+% | 5 |
| Coconut Oil Fatty Acid | 99+% | 10 |
| Sodium C₁₂-C₁₄ Alcohol Ethoxysulfate | 60% | 26 |
| Denatonium | 25% | 0.05 |
| Cleaning Enzyme | 10% | 2.5 |
| Whitening Agent | 100% | 0.2 |
| Polyethoxylated PEI | 80% | 6 |
| Sodium Sulfate 15% solution | 15% | 1.33 |
| HLB surfactant (described above for each | 100% | 5 |
| combination from HLB 2 to 16) | | |
| ZnR Solid (88% Active) | 88% | 2.5 |

Testing was performed using a LUMiSizer® dispersion analyzer (LUM GmbH) centrifuge at 25 degrees ° C. and 2,500 RPM. Measurements were taken every 10 seconds over 60,000 second test. The results of this testing are reproduced below in Table 4. RCA is Rotational Centrifugal Acceleration and is presented in gravities.

TABLE 4

| | Velocity | Velocity | RCA, |
|---|---|---|---|
| | in mm | Standard | Acceleration |
| Surfactant HLB | per month | Deviation | in gravities |
| HLB 2 | 5562 | 468.2 | 878.9 |
| HLB 4 | 4218 | 499.2 | 879.6 |
| HLB 6 | 4605 | 434.6 | 888.2 |
| HLB 8 | 1257 | 124.5 | 894.3 |
| HLB 10 | 105203 | 4761 | 879.0 |
| HLB 12 | 104047 | 6788 | 882.1 |
| HLB 14 | Unmeasurable | n/a | n/a |
| HLB 16 | Unmeasurable | n/a | n/a |
| Control | 79349 | 28,205 | 880.3 |

The information in Table 4 is shown graphically in FIG. 1. The results show that HLB 10, 12, 14, and 16 surfactants were categorically different from the HLB 2, 4, 6, and 8 surfactants. The HLB 10+ surfactants had velocities approximately 20× those of the HLB 2 to 6 surfactants. The HLB 10+ surfactants had worse results than the Control which had glycerol instead of the additional surfactant. Comparison of the mean difference vs. the standard deviations establishes that the described results are strongly significant.

In contrast, while HLB 2, 4, and 6 showed improvements compared with HLB 10+ surfactants, the HLB 8 surfactant showed superior stability compared with the HLB 2, 4, and 6 surfactants as well. Accordingly, the use of a surfactant with an about HLB 8 appears to be an optimum between the good region of HLB 2 to 6 and the poor region of HLB 10+. As noted above, this particular implementation of HLB 8 was 65% SPAN 80 and 35% TWEEN 80 (total 5 wt. % of the formulation). However, because the unstable region appears with HLB 10+, it is also reasonable to select a third surfactant with in the HLB 2 to 6 range to provide robustness.

### Example 3

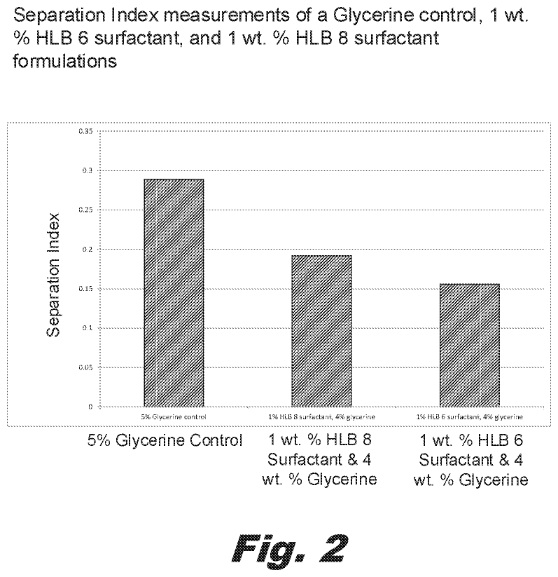

A third set of formulations was tested with 1) a glycerine control, 2) 1% HLB 6 surfactant+4% glycerine, and 3) 1% HLB 8 surfactant+4% glycerine as test samples. These 5 wt. % contributions replaced the 5 wt. % of HLB surfactant of the formulations of Example 2. All other components of the formulations of Example 2 were retained. The results were run at 1220 g for approximately 60,000 seconds. The results are documented below in Table 5 and in FIG. 2.

TABLE 5

| Test Formulation Description | Separation Index |
|---|---|
| 5% Glycerine Control | 0.289 |
| 1% HLB 8 surfactant, 4% glycerine | 0.192 |
| 1% HLB 6 surfactant, 4% glycerine | 0.156 |

Accordingly, while HLB 8 appears to provide better performance compared to HLB 2 to 6 at 5 wt. % in detergent compositions; at 1 wt. % HLB 6 provides greater stability than HLB-8 and both are improved compared with the glycerine control. In either case, the inclusion of a surfactant with an HLB below 10 improved the stability over the controls produced with the melted ZnR. The melted ZnR approach produced superior stability to the use of liquid formulations of ZnR (30 wt. %). These measured results were consistent with visual observations of the samples.

It will be appreciated that, within the principles described by this specification, a vast number of variations exist. It should also be appreciated that the examples described are only examples, and are not intended to limit the scope, applicability, or construction of the claims in any way.

What is claimed is:

1. A unit dose detergent product comprising:
a pouch made of a water soluble polymer, and
a detergent composition encapsulated in the pouch, wherein the detergent composition comprises:
0.2 to 5 wt. % of zinc ricinoleate (ZnR),
10 to 20 wt. % of a C₂-C₅ polyol;
5 to 30 wt. % of water;
5 to 25 wt. % of an alkali ethoxy alkyl sulfate surfactant; and
10 to 25 wt. % of an ethoxylated alcohol nonionic surfactant, and
1 to 10 wt. % of a third surfactant,
wherein the third surfactant has a mean HLB of 2 to 10.

2. The composition of claim 1, wherein the third surfactant has a mean HLB of 6 to 10.

3. The composition of claim 1, wherein the third surfactant comprises a non-ionic alkyl alkoxy sorbitan.

4. The composition of claim 1, wherein the zinc ricinoleate is added as a melt of a zinc ricinoleate solid.

5. The composition of claim 1, wherein the C₂-C₅ polyol comprises glycerol and propylene glycol.

6. The composition of claim 1, wherein the ethoxylated alcohol nonionic surfactant comprises a polyethylene oxide (PEO) modified fatty alcohol.

7. The composition of claim 6, wherein the ethoxylated alcohol nonionic surfactant comprises seven mol of ethoxylation per mol of surfactant.

8. The composition of claim 7, wherein the fatty alcohol comprises a saturated C₁₂-C₁₅ fatty alcohol.

9. The composition of claim 1, further comprising 1 to 5 wt. % of monoethanolamine.

10. A method of forming a detergent formulation containing zinc ricinoleate, the method comprising:
melting a solid first composition, wherein the solid first composition comprises 70 to 100 wt. % zinc ricinoleate by weight of the first composition, and
mixing the melted first composition with the other components of the formulation, wherein the other components of the formulation comprise, as percentages of the detergent formulation by weight:
5 to 30 wt. % water;
5 to 25 wt. % of active alkali ethoxy alkyl sulfate(s);
10 to 25 wt. % of an ethoxylated alcohol nonionic surfactant;
an amine; and
10 to 20 wt. % of a C₂-C₅ polyol.

11. The method of claim 10, further comprising putting the mixture into a water-soluble pouch to prepare a detergent in the form of a unit dose, wherein the detergent formulation comprises 0.3 to 3 wt. % of zinc ricinoleate and the pouch contains approximately 15 to 30 grams of the detergent formulation.

12. The method of claim 10, wherein the detergent formulation comprises 1 to 3 wt. % zinc ricinoleate.

13. The method of claim 11, wherein the detergent formulation comprises 1.3 to 1.7 wt. % zinc ricinoleate.

14. The method of claim 10, wherein the detergent formulation further comprises a surfactant having a mean HLB of 2 to 10.

15. The method of claim 14, further comprising mixing the melted first composition with the surfactant having a mean HLB of 2 to 10 prior to mixing with the other components of the formulation.

16. The method of claim 14, wherein the surfactant having a mean HLB of 2 to 10 is mixed with the other components prior to adding the melted first composition to the other components.

17. The method of claim 14, wherein the surfactant with a mean HLB of less than 10 has a mean HLB greater than 6.

18. The method of claim 14, wherein the surfactant with a mean HLB of less than 10 comprises an alkyl ethoxy sorbitan.

19. The detergent of claim 16, wherein the alkali ethoxy alkyl sulfate(s) comprises a mixture of C₁₂ to C₁₄ sodium sulfates.

20. The detergent of claim 16, wherein the C₂-C₅ polyol comprises a mixture of glycerine and propylene glycol.
